(19) United States
(12) Patent Application Publication
(10) Pub. No.: US 2012/0001862 A1
(43) Pub. Date: Jan. 5, 2012

(54) CAPACITIVE TOUCH SWITCH DISPLAY CONTROL SYSTEM AND METHOD

(75) Inventors: William Durbin, Austin, TX (US); Parker Dorris, Austin, TX (US); Jerome Cloute-Cazalaa, Chevreuse (FR)

(73) Assignee: SILICON LABORATORIES, INC., AUSTIN, TX (US)

(21) Appl. No.: 12/828,216

(22) Filed: Jun. 30, 2010

(51) Int. Cl. G06F 3/045

(52) U.S. Cl. 345/174; 345/1.1

(57) ABSTRACT

A capacitive touch switch display control system includes multiple capacitive touch switches and respective LED displays that light to indicate the status of the system. A microcontroller unit (MCU) interface includes a shared function pin for each touch switch-LED pair. The MCU configures the shared function pin as an analog pin for very brief first time periods during which the MCU disables the LED displays and conducts capacitive sensing of the touch switches connected thereto to determine their status. After the first time period, the MCU enables the LED displays for potential lighting during a second time period. During the second time period, the MCU configures the shared function pin as a digital I/O LED control pin to either light or not light the LED display to indicate the status of the system. The first time period during which the MCU conducts capacitive sensing of the touch switches is sufficiently brief that it does not interfere with LED lighting function.

### BACKGROUND

The disclosures herein relate generally to electrical interfaces, and more particularly, to electrical interfaces that couple to switches and display indicators.

Many electrical devices include panels with touch button switches and display indicators that indicate status information related to the electrical device. Monitoring circuits monitor the touch button switches to determine when a user touches a particular switch. An electrical interface provides a number of connection points or pins that couple the monitoring circuits, driver circuits and other circuits to the touch button switches, display indicators and other components. As the number of touch button switches and display indicators becomes larger, the size of the interface, i.e. the number of interface pins, may likewise become quite large.

### BRIEF SUMMARY

In one embodiment, a method of capacitive touch switch display control is disclosed that includes driving, by a controller, a display via a shared interface pin during first time periods, the shared interface pin being coupled to the display and a capacitive touch switch. The method also includes sensing via the shared interface pin, by the controller, a capacitance exhibited by the capacitive touch switch to determine a touched or untouched state of the capacitive touch switch. The sensing occurs during second time periods interleaved between the first time periods. The controller disables the display during the second time periods, the second time periods being sufficiently short in comparison to the first time periods that a user does not perceive interruptions in driving the display.

In another embodiment, a method of capacitive touch switch display control is disclosed that includes disabling for a first predetermined time period, by a controller, a plurality of displays included in an electrical device, wherein the electrical device includes a plurality of capacitive touch switches, each capacitive touch switch exhibiting a present capacitance. The method also includes sensing, by the controller, the present capacitances of the capacitive touch switches during the first predetermined time period within which the controller operates in a capacitance sensing mode. The method further includes determining, by the controller, from the present capacitances of the capacitive touch switches whether or not each capacitive touch switch is touched in the first predetermined time period. The method still further includes enabling for a second predetermined time period, by the controller, the plurality of displays to operate in a display control mode wherein the controller may activate displays to display information. The disabling, sensing, determining and commencing steps are repeated. The first predetermined time period during which the plurality of displays is disabled is sufficiently short in comparison to the second predetermined time period that a user does not sense disabling of the plurality of displays.

In another embodiment, a capacitive touch switch display control system is disclosed. The system includes an interface including a shared interface pin. The system also includes an electrical device including a display coupled to the shared interface pin, the electrical device including a capacitive touch switch coupled to the shared interface pin. The system also includes a controller coupled to the shared interface pin to sense, during second time periods interleaved between the first time periods, a capacitance exhibited by the capacitive touch switch to determine a touched or untouched state of the capacitive touch switch. The controller disables the display during the second time periods, the second time periods being sufficiently short in comparison to the first time periods that a user does not perceive interruptions in driving the display.

In another embodiment, a capacitive touch switch display control system is disclosed. The system includes an electrical device including a plurality of displays and a plurality of capacitive touch switches, each capacitive touch switch exhibiting a present capacitance. The system also includes a controller including a multiple pin interface that couples to the electrical device. The controller disables the plurality of displays for a first predetermined time period during with the controller senses the present capacitances of the capacitive touch switches while operating in a capacitance sensing mode. The controller determines from the present capacitances whether or not each capacitive touch switch is touched in the first predetermined time period. The controller enables for a second predetermined time period the plurality of displays to operate in a display control mode wherein the controller may selectively activate displays to display information. The first predetermined time period during which the plurality of displays is disabled is sufficiently short in comparison to the second predetermined time period that a user does not sense disabling of the plurality of displays.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed capacitive touch switch display control system.

FIG. 2 is a representative timing diagram that illustrates the capacitive sensing mode and display control mode that the disclosed system employs.

FIG. 3 is a more general block diagram of one embodiment of the disclosed capacitive touch switch display control system.

FIG. 4 is a flowchart that shows a representative process flow that one embodiment of the disclosed system may employ.

### DETAILED DESCRIPTION

In one embodiment, the disclosed method and apparatus employs a controller that controls both a display and a touch capacitive switch via a common interface pin. By sharing capacitive sensing (CS) and LED control functions on the same interface pin or line in this manner, the disclosed method and apparatus allows a reduction in the number of pins in an interface that would otherwise be necessary to both sense touches of a touch switches and to activate LEDs to display information.

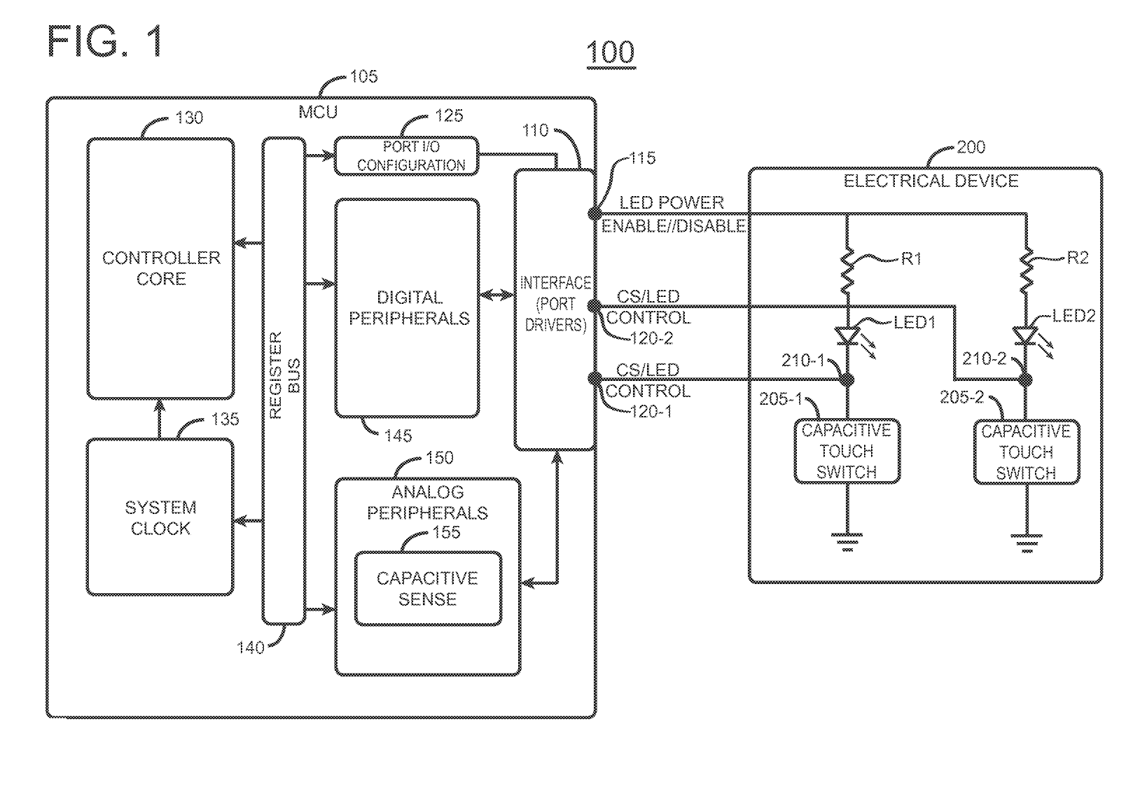

FIG. 1 depicts one embodiment of the disclosed capacitive touch switch display control system 100. System 100 includes a microcontroller unit (MCU) 105 and an electrical device 200 that includes capacitive touch sensitive switches 205-1 and 205-2 coupled to respective display indicators LED1 and LED2. Electrical device 200 may be virtually any electrical device that includes multiple capacitive touch switches with respective display indicators that activate to alert the user that a switch exhibits a particular state. For example, electrical device 200 may be a cable/satellite TV set top box, mobile phone, audio/video system, automotive switch and display assembly, broadcast video equipment, computer displays as well as many other applications that employ capacitive touch switches and respective display indicators.

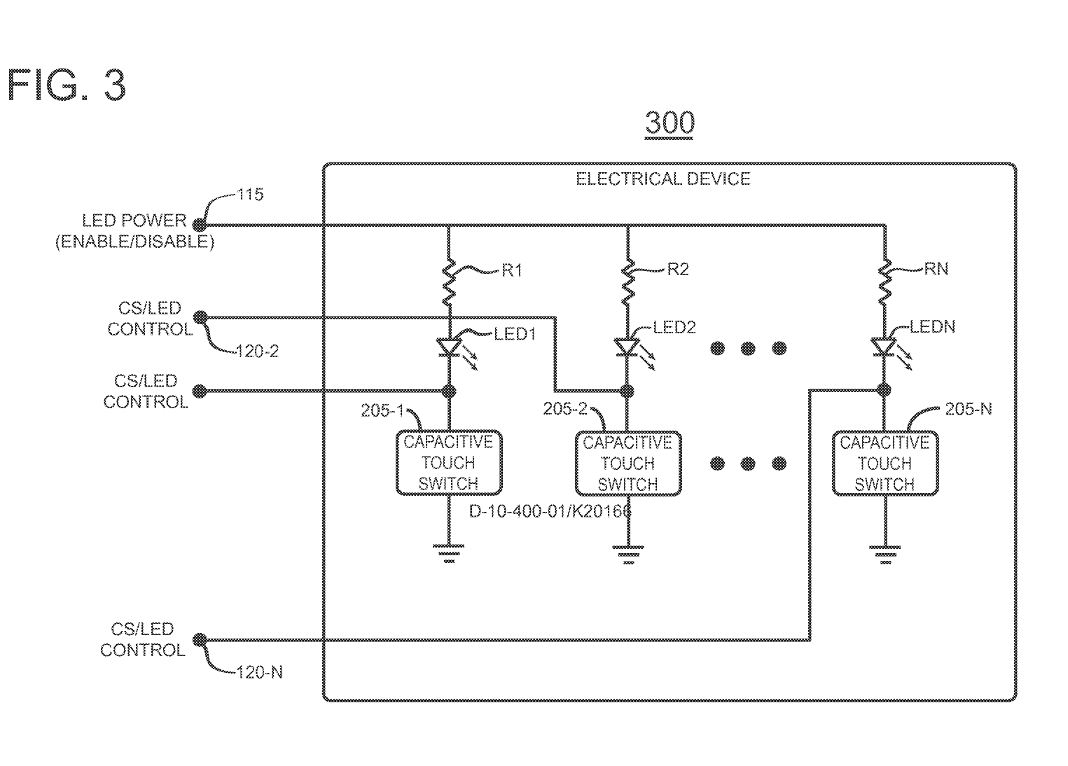

When a user touches one of switches 205-1 and 205-2, the capacitance that the touch switch exhibits changes in comparison to the capacitance of an untouched switch. In one embodiment, system 100 detects this capacitance change and in response lights the particular LED display associated with the touched switch. For example, if the user touches capacitance touch sensitive switch 205-1, system 100 detects the change in capacitance of switch 205-1 and causes LED1 to light, as explained in more detail below. In other embodiments, system 100 may light LED1 to display information not related to detecting a touch of touch sensitive switch 205-1. Other embodiments may employ more than two switches and more than two display LEDs, as discussed below with reference to FIG. 3.

MCU 105 includes an interface 110 that couples to electrical device 200. MCU 105 may be fabricated as an integrated circuit (IC) chip. Interface 110 includes multiple I/O pins that MCU 105 may configure as inputs or outputs (port drivers) depending on the particular application. Interface 110 may selectably configure these I/O pins for analog or digital operation in the manner discussed below. Interface 110 includes an LED POWER pin 115 that supplies DC power to LED1 and LED2 via resistors R1 and R2 respectively. MCU 105 may enable or disable LED POWER pin 115. Capacitive touch sensitive switches 205-1 and 205-2 couple LED1 and LED2, respectively, to ground as shown. Interface 110 also includes capacitive sensing/LED control pins (CS/LED CONTROL) pins 120-1 and 120-2 that couple respectively to a node 210-1 between LED1 and touch switch 205-1 and a node 210-2 between LED2 and touch switch 205-2, as shown. By sharing the capacitive sensing (CS) and LED control functions on the same pin or line in this manner, the topology of system 100 allows a reduction in the number of pins in interface 110 that would otherwise be necessary to both sense touches of the touch switches and to activate the LEDs to display information. Sharing LED power pin 115 with display enable/disable function among the displays such as LED1 and LED2 also allows a reduction in pins of interface 110. The information that a particular LED displays may include status information related to the operation of system 100. For example, the particular LED may form part of a multiple LED array that displays volume level, signal level or other information. A single LED, representing a single bit, may display the on/off status of a component of interest.

MCU 105 includes port I/O configuration circuitry 125 that enables MCU 105 to configure the I/O pins of interface 110 as either as digital I/O ports or analog ports. More information with respect to configuring interface I/O pins as either digital I/O ports or analog ports is disclosed in commonly owned patent application US 2008/0079148A1, by Leung et al., entitled “Package For Mixed Signal MCU With Minimal Pin Count”, published Apr. 3, 2008, and commonly owned patent application U.S. patent application US 2009/0322410 A1, by David et al., entitled “System and Method for Monitoring a Capacitive Sense Display”, published Dec. 31, 2009, the disclosures of both of which are incorporated herein by reference in their entirety. The following is a high level discussion of MCU 105. MCU 105 includes a controller core 130. System clock 135 couples to controller core 130 to provide a time base thereto. A register bus 140 couples to controller core 125 to connect controller core 125 to other components of MCU 105. Register bus 140 together with port I/O configuration circuit 125 enables controller core 130 to interface with interface operating pins, such as pins 115, 120-1 and 120-2, that provide an interface external to MCU 105 to receive digital values, output digital values, receive analog values or output analog values on those pins. In an alternative embodiment, MCU 105 and electrical device 200 may be fabricated together on a common semiconductor die or assembled together in a multi-chip module (MCM).

MCU 105 includes digital peripherals 145 and analog peripherals 150. Digital peripherals 145 may include digital circuits such as a universal asynchronous receiver transmitter (UART), timers, a system management bus (SMBUS) and a crossbar decoder, for example. The digital peripherals 145 couple to interface 110 as shown. Analog peripherals 150 include a capacitive sense circuit 155 that monitors capacitive touch switches 205-1 and 205-2 via pins 120-1 and 120-2, respectively, to determine when the user touches these switches. One capacitive sense apparatus that may be used as capacitive sense circuit 155 is disclosed in commonly owned U.S. patent application US 2009/0322410 A1, by David et al., entitled “System and Method for Monitoring a Capacitive Sense Display”, published Dec. 31, 2009, the disclosure of which is incorporated herein by reference in its entirety. Another capacitive sense apparatus that may be used as capacitive sense circuit 155 is disclosed in the publication, Silabs1 entitled “Capacitive Sensing Solutions from Silicon Labs”, downloaded from www.siliconlabs.com on Mar. 2, 2010, the disclosure of which is incorporated by reference in its entirety.

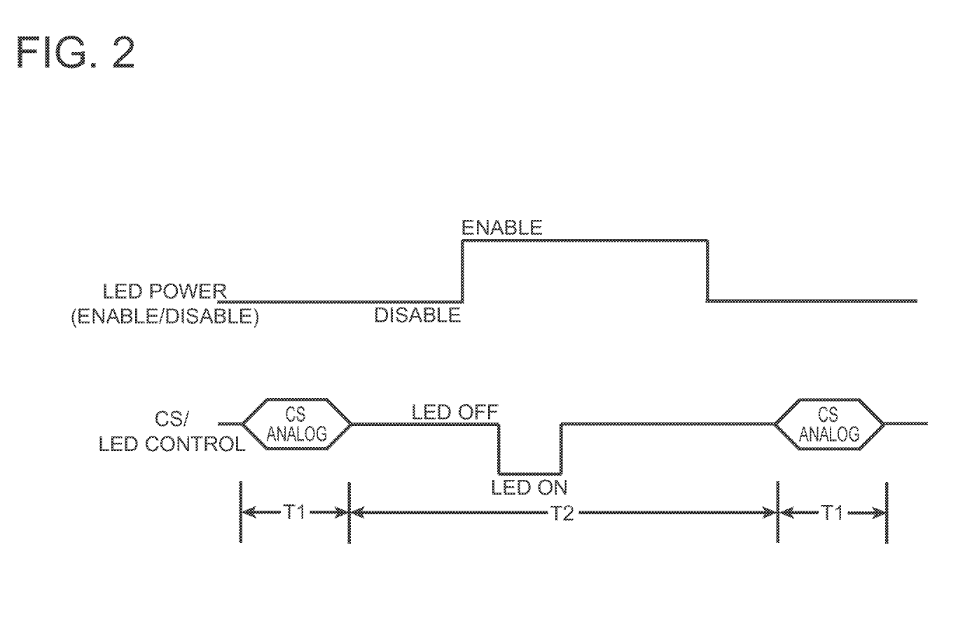

As shown in the timing diagram of FIG. 2, system 100 operates alternatingly in an analog capacitance sensing (CS) mode for short durations of time T1 and in a digital display control (LED CONTROL) mode for longer periods of time T2. In FIG. 2, the LED POWER that MCU 105 supplies to LED1 and LED2 via LED POWER pin 115 is initially low. LED1 and LED2 are effectively disabled and unable to light while LED POWER is low. For a very brief period of time, T1, MCU 105 configures CS/LED CONTROL pins 120-1 and 120-2 to operate as analog capacitance sensing pins. During T1, capacitance sensing circuit 155 of MCU 105 senses the capacitances exhibited by capacitive touch switches 205-1 and 205-2. From the capacitance information thus derived for each switch, MCU 105 determines if a user is touching one or more switches.

For discussion purposes, assume that the user is touching switch 205-1. In response to the switch touch determination or “hit” that capacitive sensing circuit 155 detects, MCU 105 may perform some system function such as conducting a desired process or activity. The T1 time period during with MCU 105 performs this capacitance sensing operation is selected to be sufficiently small that the user does not detect interference with lighting display LED1. In one embodiment, a time period T1 within the range of approximately 40 μs to approximately 60 μs was found to be sufficiently small that the user did not detect a flicker or brief outage of LED1 when lit. This time period T1 may vary to time values less than or greater than this range depending on the particular application.

When the capacitance sensing operation or CS mode completes at the end of T1, a longer time period T2 commences during which MCU 105 reconfigures CS/LED CONTROL pins 120-1 and 120-2 from operating as analog CS pins to operating as digital I/O pins that provide LED control. During time period T2, system 100 operates in a display control mode wherein the LED POWER pin 115 transitions high to make power available to LED1 and LED2 should these LEDs need to be lit to display information. In other words, LED POWER pin 115 transitions from a disabled state to an enabled state as shown in FIG. 2. To turn on a particular LED, for example LED1, MCU 105 transitions the CS/LED CONTROL pin 120-1 for LED1 from logic high (LED OFF) to logic low (LED ON) as shown in the timing diagram of FIG. 2. MCU 105 generates this transition to turn LED1 on to display information if that such information is available for display. If MCU 105 currently has no information for LED1 to display, then MCE 105 need not generate this transition. MCU 105 switches the LED POWER pin 115 to the disable state to withdraw power from LED1 and LED2 before commencing the next time period T1. Subsequently, time period T2 ends, the next time period T1 starts and the process repeats.

The following is a discussion of additional operational details of one embodiment of the disclosed system. From the timing diagram of FIG. 2, it is seen that LED1 and LED2 are not driven or supplied power (LED POWER) during the T1 time periods in which capacitive sensing of switch status occurs. This is the “capacitive sensing mode” (CS ANALOG) during which LED1 and LED2 are disabled and during which capacitive sensing of the status of touch switches 205-1 and 205-2 by capacitive sensing circuit 150 is conducted.

More particularly, MCU 105 sets the LED POWER pin 115 to low (DISABLE) during the T1 time periods thus removing power from and disabling LED1 and LED2. The human eye can not detect such a short event or interruption of LED output. LED1 and LED2 are effectively shut off for this very short period of time and any potential flicker in the LED1 and LED2 displays is not readily detectable by the user due to the shortness of the time period T1. To effectively turn off LED1 and LED2, MCU 105 employs port I/O configuration circuit 125 to configure LED POWER pin 115 as a push-pull output that is set to zero voltage. Thus, no voltage drop exists across LED1 and LED2 during the very short T1 time period.

While operating in the “capacitive sensing mode” of time period T1, MCU 105 employs port I/O configuration circuit 125 to configure the CS/LED CONTROL pins 120-1 and 120-2 as analog inputs so that capacitive sense circuit 155 may take capacitance readings from capacitive touch switches 205-1 and 205-2. MCU 105 uses the capacitance information thus derived to determine if capacitive touch switches 205-1 and 205-2 are touched.

When the analog capacitance sensing operation of time period T1 is complete, time period T2 commences and “display control mode” begins. During time period T2, MCU 105 employs port I/O configuration circuit 125 to configure LED POWER pin 115 to generate a logic high thus providing power to and enabling the lighting of LED1 and LED2 should lighting of LED1 or LED2 be desired. When LED POWER pin 115 is configured to generate a logic high in this manner, node 210-1 between the CS/LED control pin 120-1 and LED resistor R1 is initially not driven. In the “display control mode” of time period T2, MCU 105 employs port I/O configuration circuit 125 to configure CS/LED CONTROL pins 120-1 and 120-2 as digital LED control pins instead of analog capacitance sensing pins. Whereas in the “capacitive sensing mode” of time period T1 the CS/LED CONTROL pins 120-1 and 120-2 were configured as analog capacitance sensing pins, in the “display control mode” of time period T2 the CS/LED CONTROL pins 120-1 and 120-2 are configured as digital LED control pins. MCU 105 generates a logic low on pin 120-1 to turn LED1 on. To leave LED1 off, MCE 105 generates a logic high on pin 120-1. MCU 105 will either turn LED1 on or off as desired according to the particular application. MCU 105 may turn LED2 on or off in a similar manner by generating a logic low or logic high on CS/LED CONTROL input 120-2 during time period T2. After time period T2, MCU 105 returns to the capacitance sensing mode for the next brief period of time T1. MCU 105 continues alternating between capacitance sensing mode and display control mode during successive T1 and T2 time periods.

FIG. 3 shows an embodiment of electrical device 300 that includes N capacitive touch switches and respective display LEDs. In other words, N represents the number of capacitive touch switches and respective LEDs in electrical device 200. Electrical device 300 of FIG. 3 includes other components in common with electrical device 200 of FIG. 1. Electrical device 300 provides an expansion of the touch switch and LED arrangement of electrical device 200. Regardless of the value of N, each touch switch 205-1, 205-2, . . . N couples to a respective dedicated CS/LED control pin such as pin 120-N that operates alternatingly in the capacitance sensing mode and the display control mode, as described above with reference to FIG. 1. Each CS/LED CONTROL pin employs pin sharing to provide two functions, namely the capacitance sensing function of the capacitance sensing mode of the time T1 time periods and the display control function of the display control mode of the T2 time periods.

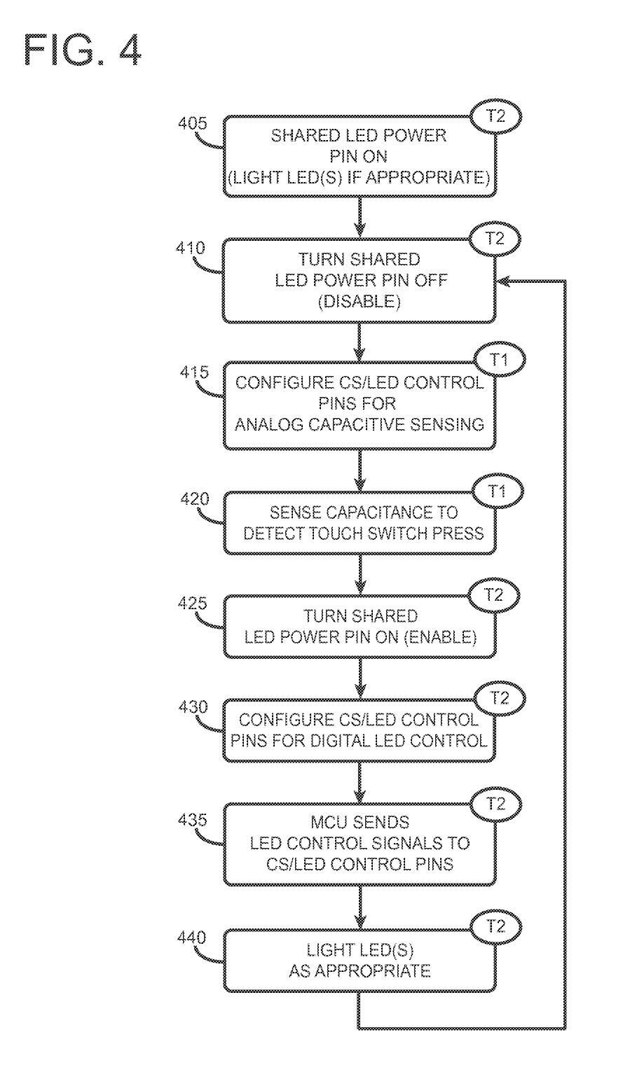

FIG. 4 is a flowchart that shows a representative process flow in one embodiment of the disclosed methodology. For discussion purposes, assume that MCU 105 is currently operating in display control mode and MCU 105 has instructed the displays LED1 and LED2 to light if appropriate. In other words, MCU 105 is operating in display control mode during time period T2. If appropriate for current conditions, MCU 105 instructs particular LEDs to turn on, as per block 405. Note that interface 110 of MCU 105 employs a dedicated shared CS/LED CONTROL pin for each capacitive touch switch 205-LED pair. The CS/LED control pins share or provide both the capacitive sense function and the LED control function described above. Sharing these 2 functions for each touch switch allows a reduction in pin count in interface 110. Displays LED1, LED2, . . . N all share a common LED POWER pin 115. LED POWER pin 115 powers and enables/disables displays LED1, LED2, . . . N.

The upper right corner of each block in the flowchart of FIG. 4 includes an oval marked either T1 to indicate that the function of the block occurs during time period T1 or marked T2 to indicate that the function of the block occurs during the time period T2. MCU 105 turns LED POWER pin 105 off before commencing capacitance sensing mode during time period T2, as per block 410. MCU 105 configures the CS/LED CONTROL pins 120-1 and 120-2 as analog inputs, as per block 415, to enable capacitive sense circuit 155 to sense the capacitance of touch switches 205-1 and 205-2, as per block 420. MCU uses this capacitance information from capacitance sense circuit 155 to determine if any of the touch switches were touched or pressed by the user.

After time period T1, system 100 again enters display control mode during period T2. MCU 105 generates a logic high on LED POWER pin 115 to enable and make power available to LED1 and LED2, as per block 425, should it be needed to light these LEDs to display currently available information. Each LED may display a single bit of information. MCU 105 configures the CS/LED CONTROL pins 120-1 and 120-2 as digital I/O ports to provide LED on/off lighting control, as per block 430. To light a particular LED to display information, MCU 105 sends an LED control signal to the CS/LED CONTROL pin for that particular LED, as per block 435, to instruct the respective LED for the particular switch to light or display, as per block 440. Process flow then continues back to block 410 and the process repeats. In other words, system 100 continues switching back and forth between the very brief-analog capacitance sensing mode of time period 1 and the digital display control mode of time period T2.

In the above described manner, pins are conserved in interface 110 of MCU 105. In the embodiment of FIG. 1 wherein there are 2 touch switches and 2 LEDs, the pin arrangement consumes 3 pins whereas other approaches without the disclosed pin sharing methodology may require 4 pins. An embodiment with 3 touch switches and 3 LEDs would employ 4 pins. An embodiment with 4 touch switches and 4 LEDs would employ 5 pins. In other words, embodiments with N touch switches and N LEDs employ N+1 interface pins.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
driving, by a controller, a display via a shared interface pin during first time periods, the shared interface pin being coupled to the display and a capacitive touch switch; and
sensing via the shared interface pin, by the controller, a capacitance exhibited by the capacitive touch switch to determine a touched or untouched state of the capacitive touch switch, the sensing occurring during second time periods interleaved between the first time periods, the controller disabling the display during the second time periods, the second time periods being sufficiently short in comparison to the first time periods that a user does not perceive interruptions in driving the display.

2. The method of claim 1, further comprising:
instructing during the first time period, by the controller, the display to exhibit a first display state if the controller determines from the capacitance of a capacitive touch switch that the capacitive touch switch was touched in the first predetermined time period, or alternatively
instructing during the first time period, by the controller, the display to exhibit a second display state if the controller determines from the capacitance of the capacitive touch switch that the particular capacitive touch switch was untouched during the second predetermined time period.

3. The method of claim 1, wherein the display is an LED.

4. The method of claim 2, wherein the first display state is one of a lit or unlit state and the second display state is the other of the lit or unlit state.

5. The method of claim 1, further comprising:
configuring, by the controller, the shared interface pin as a digital display control pin during the first time periods.

6. The method of claim 1, further comprising:
configuring, by the controller, the shared interface pin as an analog capacitance sense pin during the second time periods.

7. The method of claim 1, wherein the controller disables the display during the second time periods by removing power from the display.

8. A system, comprising:
an interface including a shared interface pin;
an electrical device including a display coupled to the shared interface pin, the electrical device including a capacitive touch switch coupled to the shared interface pin; and
a controller coupled to the shared interface pin to sense, during second time periods interleaved between the first time periods, a capacitance exhibited by the capacitive touch switch to determine a touched or untouched state of the capacitive touch switch, wherein the controller disables the display during the second time periods, the second time periods being sufficiently short in comparison to the first time periods that a user does not perceive interruptions in driving the display.

9. The system of claim 8, wherein the controller instructs during the first time period the display to exhibit a first display state if the controller determines from the capacitance of a capacitive touch switch that the capacitive touch switch was touched in the first predetermined time period, or alternatively the controller instructs during the first time period the display to exhibit a second display state if the controller determines from the capacitance of the capacitive touch switch that the particular capacitive touch switch was untouched during the second predetermined time period.

10. The system of claim 8, wherein the display is an LED.

11. The system of claim 9, wherein the first display state is one of a lit or unlit state and the second display state is the other of the lit or unlit state.

12. The system of claim 8, wherein the controller configures the shared interface pin as a digital display control pin during the first time periods.

13. The system of claim 8, wherein the controller configures the shared interface pin as an analog capacitance sense pin during the second time periods.

14. The system of claim 8, wherein the controller disables the display during the second time periods by removing power from the display.

15. An electrical device, comprising:
a plurality of displays;
a plurality of capacitive touch switches, each capacitive touch switch being coupled to a respective display to form a switch-display pair, each capacitive touch switch exhibiting a present capacitance;
a multiple pin interface coupled to the plurality of displays and the plurality of capacitive touch switches, the multiple pin interface being couplable to a controller;
a display power pin included in the multiple pin interface, the display power pin being coupled to the plurality of displays, the display power pin receiving a display power enable/disable signal which disables the plurality of displays for a first predetermined time period during which sensing of the present capacitances of the plurality of capacitive touch switches is conducted by the controller thus providing a capacitance sensing mode, the controller determining from the present capacitances whether or not each capacitive touch switch is touched in the first predetermined time period, the controller enabling for a second predetermined time period the plurality of displays to operate in a display control mode wherein the controller may selectively activate displays to display information,
wherein the first predetermined time period during which the plurality of displays is disabled is sufficiently short in comparison to the second predetermined time period that a user does not sense disabling of the plurality of displays during the capacitance sensing mode.

16. The electrical device of claim 15, wherein the controller instructs, during the second predetermined time period of the display control mode, a particular display of the plurality of displays to exhibit a first display state if the controller determines from the present capacitance of a particular capacitive touch switch associated with the particular display that the particular capacitive touch switch was touched in the first predetermined time period, or alternatively the controller instructs, during the second predetermined time period of the display control mode, the particular display to exhibit a second display state if the controller determines from the present capacitance of the particular capacitive touch switch that the particular capacitive touch switch was not touched during the second predetermined time period.

17. The electrical device of claim 15, wherein the plurality of displays comprises a plurality of LEDs.

18. The electrical device of claim 15, wherein the multiple pin interface includes a respective capacitance sense/display control pin for each of the display/capacitive touch switch pairs, wherein the controller configures the capacitance sense/display control pins as analog capacitance sense pins during the first predetermined time periods, wherein the controller configures the capacitance sense/display control pins as digital display control pins during the second predetermined time periods.

19. The electrical device of claim 18, wherein the multiple pin interface includes a common display power pin control coupled to the displays to disable the displays during the first predetermined time periods and to enable the displays during the second predetermined time periods.

20. The electrical device of claim 15, wherein the controller removes power from the plurality of displays to disable the displays.
